(19) United States
(12) Patent Application Publication
(10) Pub. No.: US 2007/0176319 A1
(43) Pub. Date: Aug. 2, 2007

(54) Aligned carbon nanotube composite ribbons and their production

(75) Inventors: Erik T. Thostenson, Geneva, IL (US); Tsu-Wei Chou, Hockessin, DE (US)

Correspondence Address: CONNOLLY BOVE LODGE & HUTZ LLP, P.O. BOX 2207, WILMINGTON, DE, 19899-2207, US

(73) Assignee: UNIVERSITY OF DELAWARE, Newark, DE (US)

(21) Appl. No.: 10/567,349

(22) PCT Filed: Aug. 6, 2004
(86) PCT No.: PCT/US04/25272

§ 371 Date: Mar. 28, 2007

Related U.S. Application Data
(60) Provisional application No. 60/492,904, filed on Aug. 6, 2003.

(51) Int. Cl. B29C 47/00

(52) U.S. Cl. 264/210.6; 264/211

(57) ABSTRACT

Carbon nanotubes can be uniformly dispersed in a polymer and subsequently fabricated in macroscopic nanotube/polymer ribbons having nanotubes aligned in a primary direction. The technique is readily scalable and could be applied to the fabrication of larger-scale structural/functional materials and devices.

### PRIOR APPLICATIONS

This application claims the benefit of U.S. Provisional Application 60/492,604, filed Aug. 6, 2003, the entire contents of which are hereby incorporated by reference.

### STATEMENT REGARDING FEDERALLY SPONSORED RESEARCH OR DEVELOPMENT

The U.S. Air Force Office of Scientific Research funded this research under contract number F49620-02-1-0328.

### BACKGROUND

1. Technical Field

The technical field includes carbon nanotube-reinforced polymer composite ribbons.

2. Related Art

The exceptional mechanical and physical properties observed for carbon nanotubes has stimulated the development of nanotube-based composite materials. Such properties observed at the nanoscale have motivated researchers to utilize carbon nanotubes as reinforcement in composite materials. At the nanoscale, the structure of the carbon nanotube strongly influences the overall properties of the resulting nanotube-based composite material. Carbon nanotubes are believed to have elastic moduli on the order of 1 TPa (1000 GPa) with strengths in the range of 30 GPa, in addition to exceptionally high electrical and thermal conductivity. These properties, combined with recent advances, have generated considerable interest in utilizing carbon nanotubes as nanoscale reinforcement in composites. Research has shown that the change in length scale of carbon nanotubes relative to carbon fibers enables selective reinforcement of the polymer matrix surrounding a carbon fiber. Local stiffening due to nanotubes results in improved load transfer at the fiber/matrix interface.

Although exceptional electrical, thermal, and mechanical properties of carbon nanotubes have been researched, expected property enhancements in composites have not been realized. One of the most significant challenges in improving the properties of nanocomposites based on carbon nanotubes is to obtain a uniform dispersion of nanotubes within the polymer matrix, which is needed to achieve good reinforcement in a composite. Because of their small size, carbon nanotubes tend to agglomerate when dispersed in a polymeric resin. In addition to slipping of nanotubes that are not adhered to the matrix, aggregates of nanotube bundles effectively reduce the aspect ratio (length/diameter) of the reinforcement.

### SUMMARY

According to a first embodiment, a method for producing nanocomposites comprises providing a mixture of polymer and nanotubes, shear mixing the mixture in an extruder, extruding the mixture, and drawing the mixture prior to solidification of the mixture.

According to a second embodiment, a nanocomposite comprises a plurality of nanotubes dispersed in a polymer matrix, wherein the nanotubes are mechanically aligned in a principal direction to a standard deviation from the principal direction of less than ±15°.

According to a third embodiment, a method for producing nanocomposites, comprises: providing a mixture of polymer and nanotubes, wherein the nanotubes are selected according to their diameters, shear mixing the mixture to disperse the nanotubes within the polymer, extruding the mixture from the extruder, and drawing the mixture prior to solidification of the mixture to form a nanocomposite, wherein the distribution of nanotube diameters is selected according to a desired stiffness of the nanocomposite.

According to the above embodiments, nanotubes are dispersed and aligned in a polymer matrix to form macroscopic ribbon of aligned composite. The method is readily scalable for creating larger-scale nanocomposites for materials and devices.

Based upon orientation of the nanotube, the resulting materials can be tailored for specific properties and may find uses in structural, electrical (e.g. EMI shielding, electronics) and thermal (e.g. heat dissipation) applications for multi-functional materials and devices based upon carbon nanotubes, and for other applications.

### BRIEF DESCRIPTION ON THE FIGURES

FIG. 1 illustrates scanning electron microscope (SEM) micrographs of as-grown carbon nanotubes;

FIG. 2 is a transmission (TEM) micrograph of variations in nanotube morphology;

FIG. 3 is a schematic view of a nanotube and an effective fiber used to model the elastic properties of nanotubes embedded in a composite;

FIG. 4 is TEM micrograph of a multi-walled carbon nanotube;

FIG. 5 illustrates the equivalence between a dispersed composite and N composites each with a specific nanotube diameter and partial volume acting in parallel;

FIG. 6 is a graphical representation of the calculation of local nanotube volume fraction when given an arbitrary distribution in nanotube diameters;

FIG. 7 is a bar graph of diameter distribution of carbon nanotubes;

FIG. 8 is a graph of diameter distribution of carbon nanotubes;

FIG. 9 is a graph of volume distribution of carbon nanotubes;

FIG. 10 is a plot of the linear relationship between wall thickness and nanotube diameter;

FIG. 11 is a plot of variation in calculated nanotube density with outside diameter;

FIG. 12 is a histogram of distribution of nanotube density;

FIG. 13 is a micrograph of process-induced alignment of nanotubes in a model nanocomposite system according to an embodiment of the present invention;

FIGS. 14A and 14B are TEM micrographs showing local distortion of the nanotube composite because of the microtome cutting process;

FIG. 15 is an image analysis showing the alignment of carbon nanotubes along the principal material direction;

FIG. 16 illustrates the geometry for two-dimensional x-ray scattering in transmission mode;

FIG. 17 shows schematics of the nanocomposite structures and the related two-dimensional scattering patterns;

FIG. 18 shows the two-dimensional scattering data integrated in the radial direction;

FIG. 19 is a bar graph of average elastic modulus results at 25° C.;

FIG. 20 is a plot of the influence of nanotube diameter, volume fraction and length on the elastic properties of an aligned nanocomposite system;

FIG. 21 illustrates the influence of nanotube weight percentage, length and diameter distribution on the elastic modulus of nanotube composites;

FIGS. 22A and 22B are scanning electron micrographs of bulk carbon nanotubes that are entangled and form large agglomerates;

FIG. 23 is a TEM micrograph of the cross-section of a polymer composite where the nanotubes are uniformly dispersed and aligned in a primary direction according to an embodiment of the present invention;

FIG. 24 is a schematic diagram showing the configuration of a micro-scale twin-screw extruder and the apparatus for drawing films from polymer melt;

FIG. 25 illustrates the mass extruded from the barrel during the formation of both nanocomposite and polymer films;

FIG. 26 shows TGA results for the different compositions;

FIG. 27 shows the first derivative of the TGA scans;

FIGS. 28A and 28B are TEM micrographs of nanocomposite films that were extruded using a microcompounder;

FIGS. 29A and 29B show results of a constant frequency temperature scan on the elastic and damping behavior of the films made in a hot press and drawn from a melt, respectively;

FIG. 30 shows the average storage modulus results at 25° C. for various films;

FIG. 31 shows that, in addition to the increase in elastic modulus, orientation of nanotubes improves yield strength and ultimate strength as compared to unreinforced polystyrene films;

FIG. 32A is a TEM micrograph of a nanocomposite film specimen showing a crack interacting with nanotube reinforcement; and

FIG. 32B illustrates broken nanotubes at a crack tip.

### DETAILED DESCRIPTION

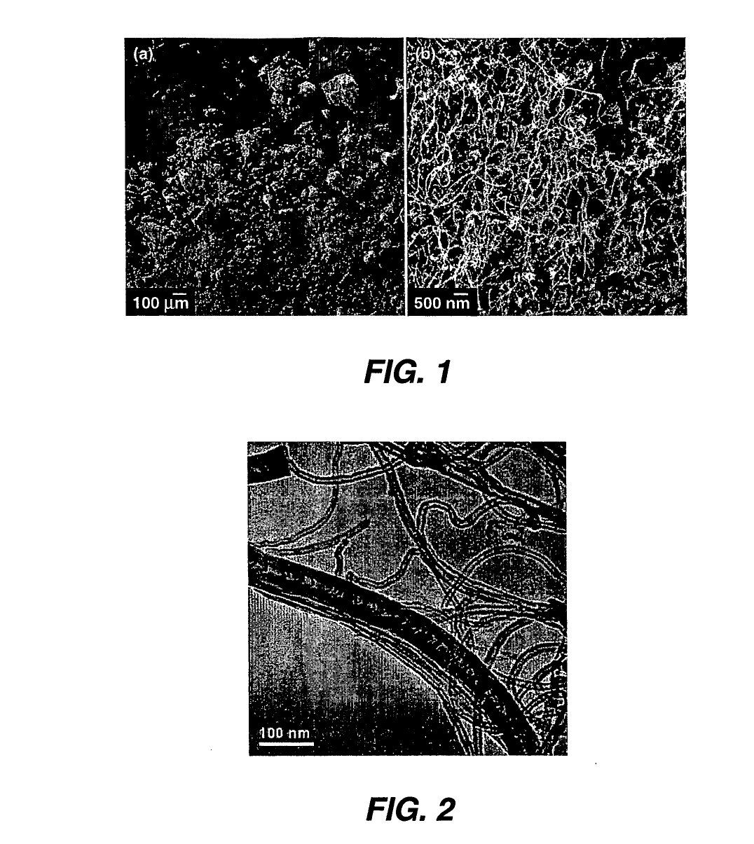

In composite materials there exists a strong interrelationship between the local structure at the micro or nano scales and the bulk properties. The local internal structure of a composite is formed during the processing step. FIG. 1 illustrates SEM micrographs of as-grown carbon nanotubes, prior to processing. After growth, the nanotubes are agglomerated as large clumps of black powder. FIG. 1(a) is a low magnification image of the bulk nanotube powder showing large agglomerates. These agglomerates result from substantial nano-scale spaghetti-like entanglement of the carbon nanotubes, as shown in FIG. 1(b). The mechanical interlacing of carbon nanotubes is a significant barrier toward achieving a homogeneous dispersion of nanotubes in a composite. In addition to nanotube entanglement, FIG. 2 illustrates large variations in nanotube outside diameters.

To utilize nanotubes in a practical material or device, nanotubes should be separated and oriented in a way to take advantage of their nanoscale properties. For example, the properties of nanotube composites are strongly influenced by nanotube diameter and orientation. For multi-walled nanotubes, there is typically a distribution of diameters, and modeling the diameter distribution of the reinforcement allows for accurate modeling of overall nanotube composite elastic properties.

Methods of processing nanotube composites according to the present embodiments produce nanotube composites where individual nanotubes are both dispersed homogeneously throughout the matrix phase, having nanoscale dispersion, and nanoscale alignment in a primary direction. In one embodiment, a nanotube composite includes carbon nanotubes and has the form of a macroscopic ribbon of aligned composite.

According to the present embodiments, such dispersion and alignment can be achieved through the use of high-shear-stress mixing of a molten polymer using a twin-screw extruder followed by extrusion and extensional flow prior to solidification. Shear stresses break up the large agglomerates and disperse nanotubes throughout the matrix, and extensional flow prior to solidification serves to further untangle the nanotubes and align them in the direction of extension.

The methods for fabrication of carbon nanotube composite ribbons according to the present embodiments are readily scalable and can be applied to the fabrication of larger-scale structural/functional materials and devices. Based upon orientation of the nanotubes, the materials can be tailored for specific properties and may have uses in structural, electrical (e.g. EMI shielding, electronics) and thermal (e.g. heat dissipation) applications for multi-functional materials and devices based upon carbon nanotubes.

The present embodiments address the need to describe the fundamental reinforcement mechanisms in nanotube-based composites and develop methods to relate the nanotube nanoscale structure to the properties of nanotube-based composites. In one embodiment, taking into account the nanoscale features of a carbon nanotube, a micromechanical model is applied to determine the composite elastic properties of nanotubes based on the properties of the constituent materials and the structure of carbon nanotubes.

The micromechanics may then be applied to a processing technique for a model system of multi-walled carbon nanotubes embedded in a thermoplastic or thermoset polymer mix such as, but not limited to, polystyrene polymer matrix. Continuous macroscopic ribbons of aligned nanocomposites may be formed using the processing technique. The nanoscale structure of the composites may be characterized using electron microscopy and x-ray diffraction.

Solvent dispersion may be utilized to obtain micron-scale dispersion of the nanotubes in the polymer matrix, followed by melt compounding with the micro-scale twin-screw extruder to achieve nanoscale dispersion. The micro-scale compounding provides the high shear mixing necessary to untangle the CVD-grown multi-walled nanotubes and to disperse the nanotubes uniformly in the thermoplastic polymer matrix.

Highly aligned nanocomposite films can be produced by extruding the polymer through a rectangular die and controlled drawing of the film prior to solidification. Electron microscopy and x-ray diffraction results indicate that both the shear and extensional flows result in significant process-induced alignment of the nanocomposite structure. The method of extruding and drawing the molten polymer creates a continuous ribbon of aligned nanocomposite that may then be laminated using traditional composites processing methods, such as autoclave molding or tape placement, to create macro-scale aligned nanocomposites.

The following discussion is addressed to modeling techniques used to predict elastic properties in nanotube reinforced composites.

According to the present embodiments, the structure of the nanotube is taken into account and the properties of an “effective fiber” are defined. The definition of effective fiber properties is then used to determine the elastic properties of a resulting composite including the nanotubes based on a micromechanics approach. Micromechanical models for discontinuous fiber composites include the shear-lag analysis, plane stress elasticity solutions, and the bound approach. According to the present embodiments, the approach of Halpin and Tsai (J. C. Halpin and S. W. Tsai, Environmental Factors in Composite Materials Design, U.S. Air Force Technical Report AFML TR 67-423 (1967) and J. C. Halpin, Primer on Composite Materials: Analysis, Technomic Publishing Company, Lancaster, Pa. (1984)), are utilized to determine the properties of a unidirectional discontinuous fiber composite. Other methods, however, may be used.

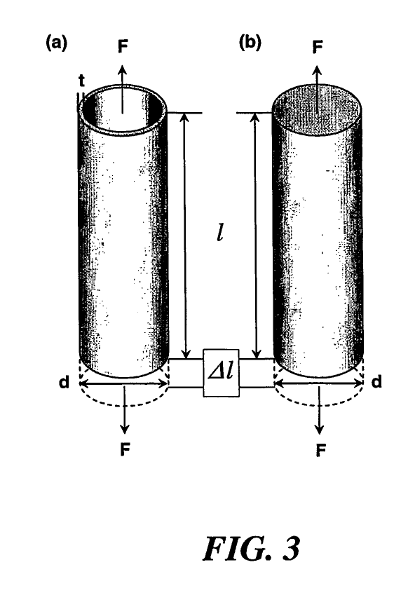

According to the present embodiments, when modeling the properties of a nanotube-based composite, the nano-scale structure of multi-walled carbon nanotubes is considered as well as the load transferring from the matrix to the nanotube via shear stresses at the nanotube/matrix interface. To determine the effective elastic modulus of a nanotube embedded in a composite, the load carrying capability of the outer layer of the nanotube is applied to the entire cross-section of the nanotube. The elastic modulus of the nanotube may be modeled by considering that the outer wall of the nanotube acts as an effective solid fiber with the same deformation behavior and same diameter (d) and length (l) shown in FIG. 3. An applied external force on the nanotube and the fiber will result in an iso-strain condition:
ε_{NT}=ε_{eff} (1)
where the subscripts NT and eff refer to the nanotube and effective fiber, respectively. From Equation (1) the elastic properties of the nanotubes are related to that of an effective fiber:

$${E}_{eff} = \frac{{σ}_{eff}}{{σ}_{NT}} {E}_{NT} \qquad ( 2 )$$

Because the applied external force is the same, the effective moduli can be expressed in terms of the ratio of their cross-sectional areas.

$${E}_{eff} = \frac{{A}_{NT}}{{A}_{eff}} {E}_{NT} \qquad ( 3 )$$

After substituting, the modulus of the effective fiber can be expressed in terms of the elastic modulus of the nanotube, the nanotube outer layer thickness (t=0.34 nm), and the nanotube diameter (d).

$${E}_{eff} = \frac{4 t}{d} {E}_{NT} \qquad ( 4 )$$

It is understood that the above expression is valid for (t/d)<0.25.

Various models are suitable to predict the elastic properties of fiber composites in terms of the properties of the constituent materials. Many solutions can be reduced to the following general form and is widely referred to as the Halpin-Tsai equations:

$$\begin{matrix}{E}_{c} = {E}_{m} ( \frac{1 + ζη {V}_{f}}{1 - η {V}_{f}} ) & ( 5 ) \\ η = \frac{\frac{{E}_{f}}{{E}_{m}} - 1}{\frac{{E}_{f}}{{E}_{m}} - ζ} & ( 6 )\end{matrix}$$

where E_{c}, is the composite elastic modulus, V_{f} is the fiber volume fraction, E_{f} and Eₘ are the fiber and matrix modulus, respectively. In Equations (5) and (6), the parameter ζ is dependent on the geometry and boundary conditions of the reinforcement phase. For an aligned short fiber composite, this parameter can be expressed as:

$$ζ = 2 \frac{ℓ}{d} + 40 {V}_{f} \qquad ( 7 )$$

and for low volume fractions:

$$ζ = 2 \frac{ℓ}{d} \qquad ( 8 )$$

The nanocomposite elastic modulus can be expressed in terms of the properties of the polymer matrix and the nanotube reinforcement:

$${E}_{11} = {E}_{m} ( 1 + 2 ( \frac{ℓ}{d} ) ( \frac{\frac{{E}_{NT}}{{E}_{m}} - \frac{d}{4 t}}{\frac{{E}_{NT}}{{E}_{m}} - \frac{ℓ}{2 t}} ) {V}_{NT} ) {( 1 - ( \frac{\frac{{E}_{NT}}{{E}_{m}} - \frac{d}{4 t}}{\frac{{E}_{NT}}{{E}_{m}} - \frac{ℓ}{2 t}} ) {V}_{NT} )}^{- 1} \qquad ( 9 )$$

where, following standard notation used for traditional fibrous composites, E₁₁ is the elastic modulus in the principal material direction, which is the direction of nanotube orientation. Equation (9) is valid for l>d>4 t. The nanotube diameter must be known since the reinforcement efficiency of the nanotube changes with diameter.

For multi-walled carbon nanotubes, there will typically be a distribution of nanotube diameters in a given sample. Experimental data for nanocomposites are typically expressed in terms of the weight fraction of reinforcement. The nanotube weight fraction (W_{NT}) does not explicitly describe the content of reinforcement because it depends on the relative densities of the matrix and the nanotube. Furthermore, the nanotube diameter and wall structure will significantly influence the nanotube density. As a consequence, it is important to have knowledge of the size and structure of the carbon nanotubes used in processing of the composite system.

The distribution of nanotube diameters for a specific nanotube sample can be determined by measuring the outside diameter of a statistically large sample of nanotubes and then using the experimental data to determine the probability distribution of nanotubes ξ(d). For the purpose of modeling the composite elastic properties, the volume fraction of carbon nanotubes within the composite are relevant. From the diameter distribution the volume distribution of nanotubes per unit length ψ(d) can be defined:

$$ψ ( d ) = \frac{{d}^{2} ξ ( d )}{{\int }_{0}^{∞} ( {d}^{2} ξ ( d ) ) ⅆ ( d )} \qquad ( 10 )$$

The above volume distribution is considered when calculating the overall nanocomposite properties.

The density of the nanotubes and the polymer matrix are used for the conversion of weight fraction to volume fraction for predicting elastic properties (Equation (9)). For fibrous composites, the volume fraction of fibers can be calculated based on the density of the constituents:

$$\begin{matrix}{V}_{f} = \frac{{ρ}_{c}}{{ρ}_{f}} {W}_{f} & ( 11 ) \\ {ρ}_{c} = {ρ}_{f} {V}_{f} + {ρ}_{m} {V}_{m} & ( 12 )\end{matrix}$$

where the ρ is density and the subscripts f, m and c refer to the fiber, matrix and composite, respectively. Substituting (12) into (11) the volume fraction can be calculated from:

$${V}_{f} = \frac{{W}_{f}}{{W}_{f} + \frac{{ρ}_{f}}{{ρ}_{m}} - \frac{{ρ}_{f}}{{ρ}_{m}} {W}_{f}} \qquad ( 13 )$$

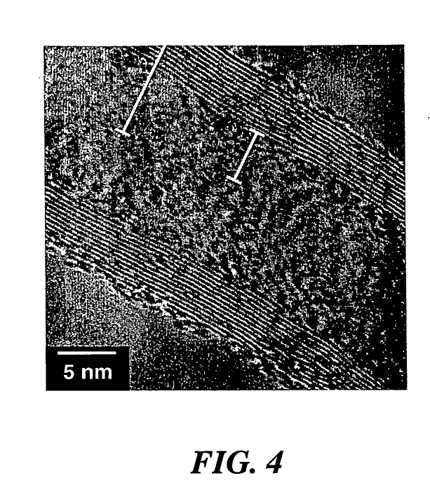

FIG. 4 is a TEM micrograph of a multi-walled carbon nanotube. The outside diameter (d) and inside diameter (dᵢ) of the nanotube can be measured directly from the micrograph using image analysis. From the measurements of inside and outside diameter, the nanotube density can be calculated:

$${ρ}_{NT} = \frac{{ρ}_{g} ( {d}^{2} - {d}_{i}^{2} )}{{d}^{2}} \qquad ( 14 )$$

The density of a multi-walled nanotube will increase with the number of walls (thickness of the outer shell).

Equation (9) expresses the diameter-dependence of the carbon nanotube reinforcement on the nanocomposite properties. To accurately model the elastic properties of the composite, the contribution to the overall elastic modulus for each nanotube diameter and the volume fraction that tubes of a specific diameter occupy within the composite are accounted for. If the nanotubes are uniformly dispersed and aligned throughout the matrix phase, the contribution of each diameter can be considered to act in parallel. Therefore, the elastic modulus of the composite can be calculated as a summation of parallel composites over the range of nanotube diameters.

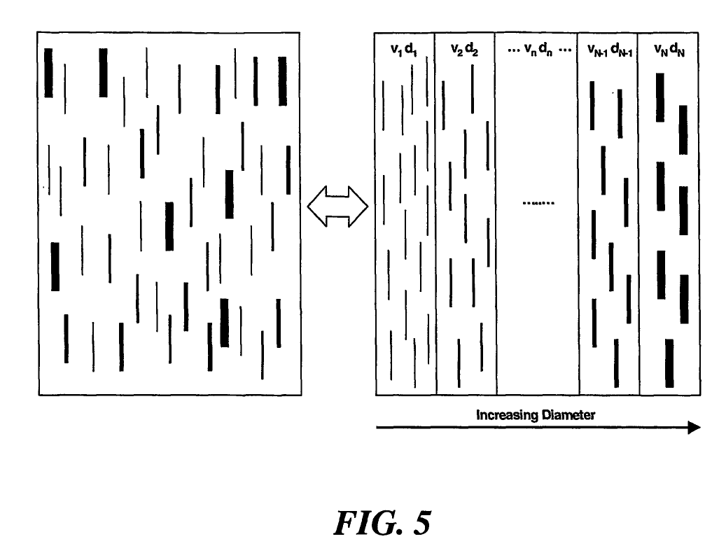

FIG. 5 illustrates the equivalence between a dispersed composite and N composites, each with a specific nanotube diameter and partial volume acting in parallel. With the assumption of iso-strain, the modulus of the composite can be expressed as a summation of the moduli scaled by the partial volume of each n^{th} composite:

$${E}_{c} = {\sum }_{n = 1}^{N} {v}_{n} {E}_{n \vert {d}_{n}} \qquad ( 15 )$$

where Eₙ|_{d}_{ₙ} is the elastic modulus of the composite calculated from Equation (9) at the nanotube diameter included in the n^{th} segment and vₙ, is the partial volume of the n^{th} composite:

$$\begin{matrix}{v}_{n} = \frac{{V}_{n}}{V} & ( 16 ) \\ {\sum }_{n = 1}^{∞} {v}_{n} = 1 & ( 17 )\end{matrix}$$

where Vₙ is the volume of the n^{th} composite and V is the overall composite volume.

To calculate the modulus at a given diameter, Eₙ in Equation (15), the local volume fraction at a given nanotube diameter, V_{NT}|_{d}, can be calculated from the volume distribution of nanotubes (Equation 10).

$${V}_{NT \vert {d}_{n}} = \frac{{\int }_{{d}_{n}}^{{d}_{n} + Δ {d}_{n}} ( {V}_{NT} ψ ( d ) ) ⅆ ( d )}{{v}_{n}} \qquad ( 18 )$$

where V_{NT} is the total volume fraction of tubes in the composite calculated from Equation (13) and the limits of the integral are the range of diameters included in the n^{th} composite.

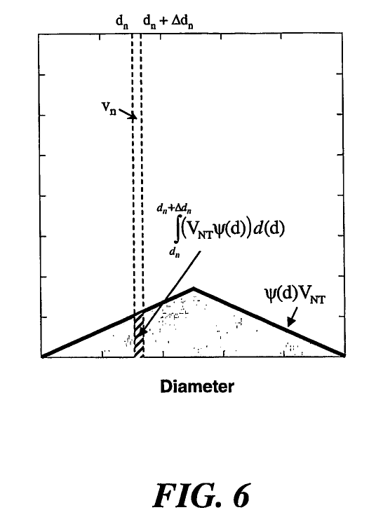

FIG. 6 is a graphical representation of the calculation of local nanotube volume fraction when given an arbitrary distribution in nanotube diameters, and illustrates schematically the computation for the nanocomposite elastic modulus described in Equations (15-18). The solid curve in FIG. 6 is the product of some arbitrary nanotube volume distribution, ψ(d), and nanotube volume fraction, V_{NT}, within the composite. The shaded area beneath the curve represents the nanotube volume fraction. The n^{th} composite is a narrow “slice” of the graph, represented by the dashed vertical lines, where there exists a narrow distribution of nanotube diameters □dₙ. The partial volume of the n^{th} composite, vₙ in Equation (16), is then the area between those dashed lines. Calculation of the local volume fraction of nanotubes in the n^{th} composite is simply the area between the dashed lines underneath the solid curve, shown by the hatched area, divided by the total area between the dashed lines.

To predict the elastic modulus of a nanotube composite system, information on the structure of the nanotubes as well as the structure of the nanocomposite is required. According to the present embodiments, a model composite is produced of aligned multi-walled carbon nanotubes embedded in a polystyrene matrix. The structure of both the nanotube reinforcement and the nanocomposite may be quantified using electron microscopy, and the elastic properties characterized using a dynamic mechanical analyzer (DMA). The mechanical characterization results are then compared with structure/property modeling approach discussed above.

The processing and structural characterization of nanotubes-based composites, according to the present embodiments, will now be discussed.

One of the most significant difficulties in processing of nanotube composites is to obtain a uniform dispersion of nanotubes within the polymer matrix. In particular, CVD-grown carbon nanotubes become entangled during the nanotube growth process. In addition to uniform dispersion of nanotubes within the matrix, it is important to process model systems with controlled structure and alignment so that the anisotropic properties of nanotube-based composites can be understood.

A micro-scale twin-screw extruder may be utilized to obtain high shear mixing necessary to untangle the CVD-grown multi-walled nanotubes and disperse them uniformly in a polystyrene thermoplastic matrix. To create an aligned system, the polymer melt is extruded through a rectangular die and drawn under tension prior to solidification. The process of extruding the nanocomposite through the die and subsequent drawing results in a continuous ribbon of aligned nanocomposite.

To quantify the structure for the nanotubes, high-resolution TEM micrographs were taken of CVD-grown tubes and image analysis software was utilized to measure the structural dimensions to quantify both the distribution of nanotube diameters and the nanotube wall structure.

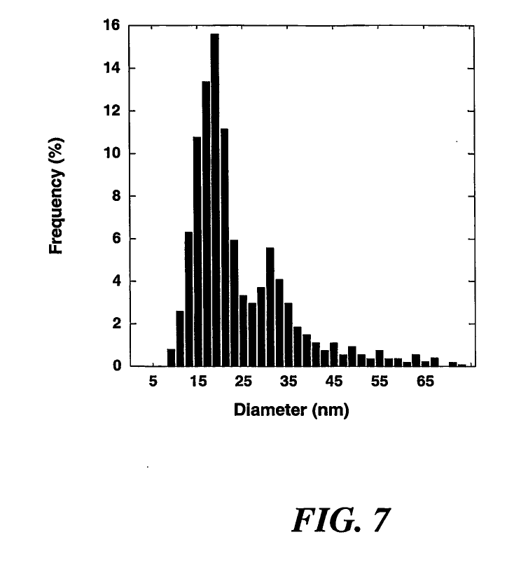

To obtain a statistically meaningful distribution of nanotube diameters, measurements were taken of the outside diameter of nearly seven hundred nanotubes. FIG. 7 illustrates the resulting histogram for the nanotube diameter distribution. To obtain a probability density function for the nanotube diameter distribution, Levenberg-Marquardt nonlinear regression was used to fit the data to a double Lorentzian distribution and a double Gaussian distribution and the curves were normalized such that the area under the curve is unity. Equations (19) and (20) are the general forms for the double Lorentz and Gauss equations, respectively.

$$\begin{matrix}ξ ( d ) = \frac{{a}_{1}}{{( 1 + \frac{d - {a}_{2}}{{a}_{3}} )}^{2}} + \frac{{a}_{4}}{{( 1 + \frac{d - {a}_{5}}{{a}_{6}} )}^{2}} & ( 19 ) \\ ξ ( d ) = {a}_{1} {ⅇ}^{( - {( \frac{d - {a}_{2}}{{a}_{3}} )}^{2} )} + {a}_{4} {ⅇ}^{( - {( \frac{d - {a}_{5}}{{a}_{6}} )}^{2} )} & ( 20 )\end{matrix}$$

The curve fit parameters for the nanotube diameter distributions are shown in Table 1 where the units for nanotube diameter are expressed in nanometers.

TABLE 1
Curve Fit Parameters for the Diameter Distribution Functions

| | a₁ | a₂ | a₃ | a₄ | a₅ | a₆ |
|---|---|---|---|---|---|---|
| Lorentz | 0.8025 | 18.23 | −3.56 | 0.02149 | 31.84 | 2.946 |
| Gauss | 0.0234 | 31.78 | 5.84 | 0.0758 | 18.03 | 5.1176 |

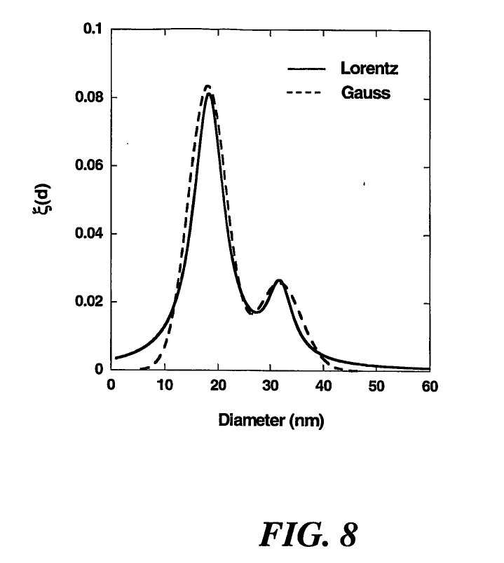

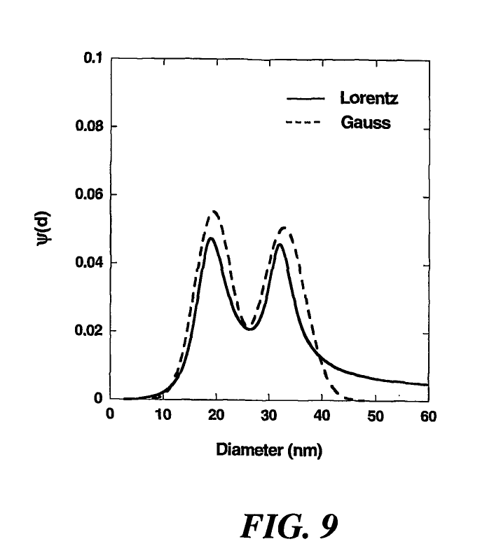

The Lorentzian and Gaussian probability distributions obtained from the experimental data are shown in FIGS. 8 and 9. For small diameter nanotubes, the Gaussian curve most accurately fits the data, but for large-diameter nanotubes, the Gaussian curve underestimates the amount of nanotubes. As discussed previously, accurate modeling of the distribution at large nanotube diameters is advantageous because the volume occupied by a given nanotube in the composite varies with d².

FIG. 9 shows plots of volume distributions (Equation (10)) for both the Lorentzian and Gaussian distributions obtained from the experimental data according to the present embodiments. In the volume distribution, the relative area under the curve shifts to the larger diameters. Although the height of the peak at 18 nm is 3 times the height of the peak at 30 nm in the diameter distribution, the two peaks are almost equal in the volume distribution. The Gaussian curve significantly underestimates the large percentage of volume occupied by large nanotube diameters. Although the large diameter nanotubes are a relatively small percentage of the total number of nanotubes, they occupy a significant percentage of volume within the composite. The Lorentzian curve fit overestimates the number of small diameter nanotubes present, but the difference in the volume distribution for the Gauss and Lorentz curves at small nanotube diameter is insignificant.

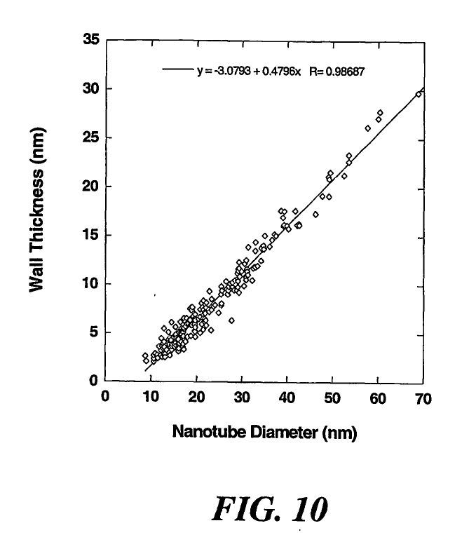

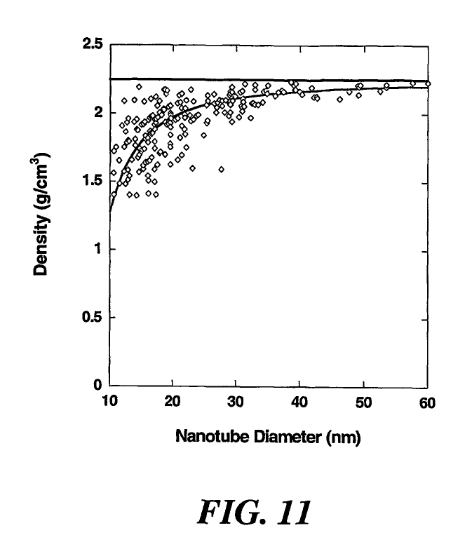

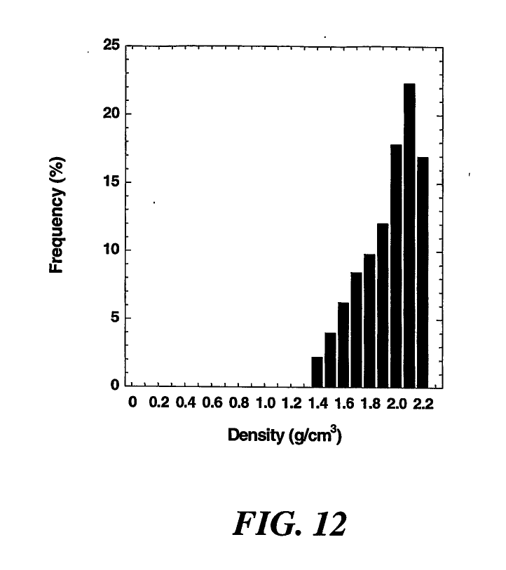

The nanoscale tubular structure of the carbon nanotube also results in a distribution of nanotube density. To calculate the density of nanotubes as a function of nanotube diameter, the outside and inside diameters were measured from TEM micrographs. FIG. 10 is a plot of experimental data, indicating a strong linear relationship between nanotube diameter and wall thickness. At smaller nanotube diameters, the relationship between wall thickness and nanotube diameter begins to deviate from the linear curve fit. Using Equation (14), the density of the nanotubes can be calculated from the experimental data. The nanotube density as a function of diameter is shown in FIG. 11, where the curved line is obtained directly from the straight line in FIG. 10. At larger nanotube diameter, the density of the nanotubes approaches the theoretical density of graphite. FIG. 12 shows the histogram of calculated nanotube density, and the mean density is 1.9 g/cm³.

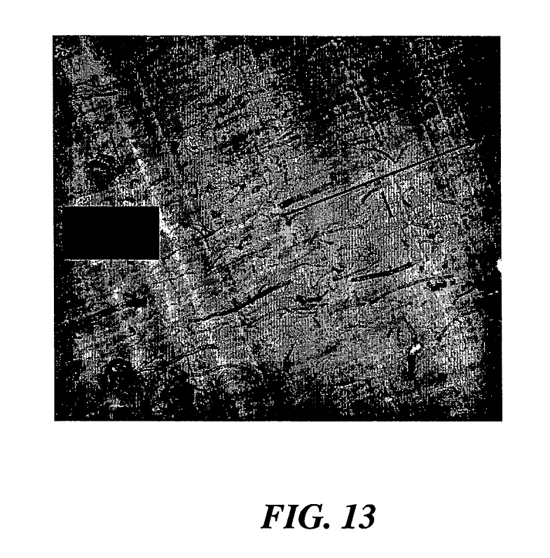

FIG. 13 is a TEM micrograph of as-processed 5 wt. % nanocomposite film showing large-scale dispersion and alignment of carbon nanotubes in a polymer matrix according to the present embodiments. The arrow indicates the direction of alignment taken as the principal material direction with a nanotube orientation of 0°. The gray lines perpendicular to the arrow in the TEM micrograph are artifacts from the microtome cutting process and indicate that the film was cut normal to the direction of orientation. To quantify the degree of alignment in the nanocomposite films, image analysis was performed on the micrographs to examine the nanotube orientation. To avoid significant distortion of the nanocomposite structure from the microtome cutting process, the samples were relatively thick (200 nm) for TEM. However, the cutting process resulted in some local distortion of the nanocomposite structure.

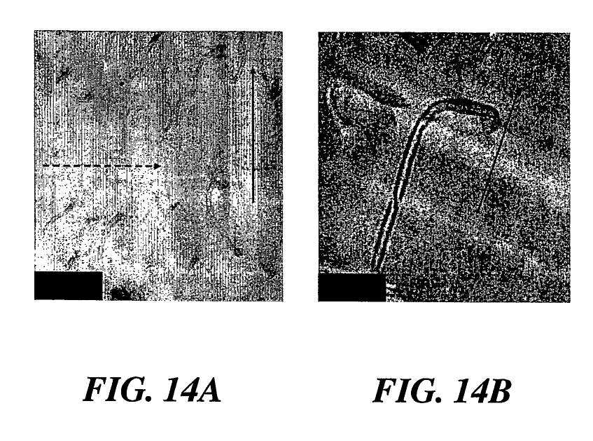

FIGS. 14A and 14B are higher-magnification TEM images that show local distortion in a nanocomposite film according to the present embodiments. FIG. 14A shows nanoscale alignment of the film in the direction indicated by the solid arrow, but near the nanotube ends, it can be seen that the tubes are sharply bent to the right (FIG. 14B). This local distortion is a consequence of cutting across the nanocomposite film where the diamond knife cuts through a nanotube. The darker regions seen at some of the nanotube ends indicates that the tube has been cut. Based on the common direction that the cut nanotubes are bent, it is reasonable to infer that the cutting direction is from left to right in FIG. 14A. The cutting direction is indicated by the dashed arrows.

To analyze the orientation of the nanotubes in the films, the direction of orientation is taken as the primary axis of the tube and the curvature at the nanotube end, which is simply an artifact of the cutting process, is ignored. In addition, tube fragments that are shorter than 200 nm are ignored in the image analysis.

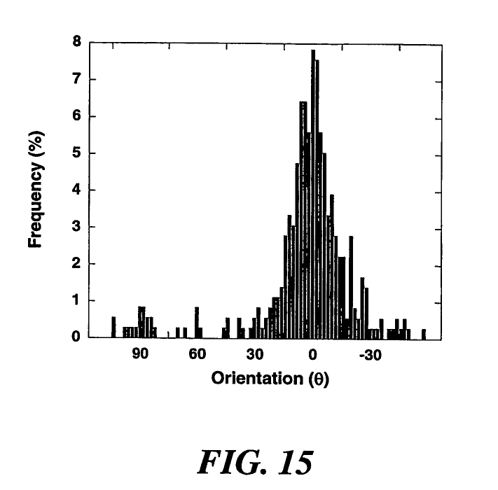

FIG. 15 shows the distribution of nanotube alignment based on the image analysis. The slight peak in the nanotube distribution at 90° is likely a consequence of damage induced by the microtome cutting. Based on the data, the standard deviation of nanotube alignment from the principal material direction is less than ±15°.

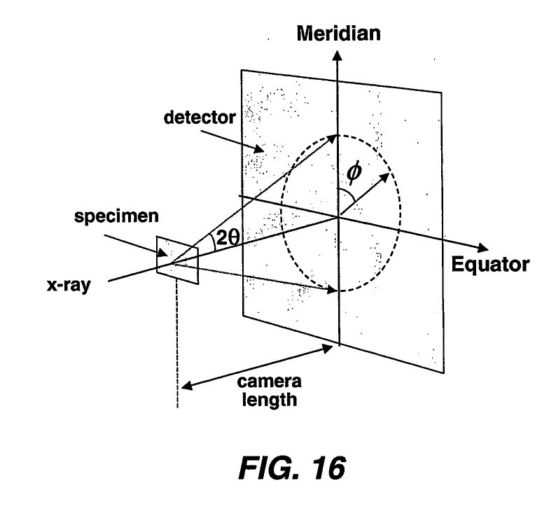

X-ray diffraction and polarized Raman spectroscopy may be used to probe the degree of orientation of carbon nanotubes. Although electron microscopy is effective in directly investigating the nanoscale structure and orientation in nanotube-based composites, TEM is only able to survey very small volumes of the overall specimen. The thickness of the as-microtomed sections is approximately 200 nm (0.2 μm), and for adequate image resolution the largest area over which a TEM micrograph can be taken is on the order of a few square microns. In x-ray scattering, the incident beam interacts with a much larger volume of material and the scattering behavior can be utilized to gain insight into the micro and nanoscale structure of the composite. FIG. 16 illustrates the geometry for two-dimensional x-ray scattering in transmission mode. In the small-angle regime, the scattering involves regions of different electron densities, and small-angle scattering arises from the difference between the electron densities between the nanotube and the polymer matrix. Randomly oriented specimens result in isotropic scattering and a specific reflection will show up as a circular ring in the two-dimensional scattering pattern. For an aligned system the ring will break up into arcs along the circumference of the ring, known as the azimuthal direction φ. The reflection for a perfectly aligned system would be represented as a single point on the ring circumference. The two-dimensional scattering patterns can be subsequently integrated to obtain one-dimensional scattering (intensity vs. 2θ) and texture (intensity vs. φ) profiles.

The SAXS and WAXS investigations were performed in transmission mode using point collimation and data were collected on a two-dimensional CCD detector.

Wide-angle measurements were made with Cu Kα radiation (λ=0.15405 nm) and small-angle measurements were performed with incident radiation from the National Synchrotron Light Source at Brookhaven National Laboratory (λ=0.1548 nm). For measurements on aligned and random nanocomposites, the films were laminated by stacking pieces of the film and sandwiching them between layers of Kapton polyimide tape. Measurements were also performed on the Kapton tape and the scattering background was removed.

At small angles, the length scale in nanotubes probed via x-ray scattering corresponds to the carbon nanotube diameters and can be used to examine the flow-induced orientation. Nanotube curvature, bamboo-like defects, distribution in nanotube diameters, and variations in the number of concentric nanotubes complicate the scattering represented by the diameter of a multi-walled carbon nanotubes.

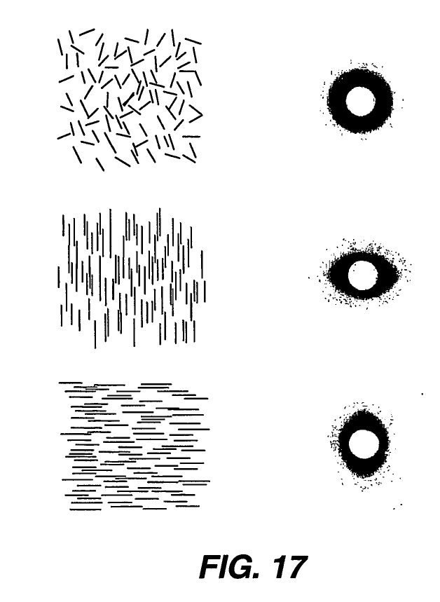

Scattering measurements were performed on aligned and random nanocomposites as well as drawn polystyrene films. The specimens were rotated and translated between scans to ensure that the observed anisotropy in scattering was related to the bulk nanocomposite structure. FIG. 17 shows schematics of the nanocomposite structure as observed via TEM and the related two-dimensional scattering patterns. The randomly oriented nanocomposite specimens (prepared by hot-pressing the dispersed nanocomposite into a film) show an isotropic, circular scattering pattern. The aligned nanocomposite specimens show anisotropic scattering. When the aligned nanocomposite specimens are oriented along the detector meridian or equator there is increased scattering in direction normal to the orientation, indicating that there is significant alignment of the carbon nanotubes.

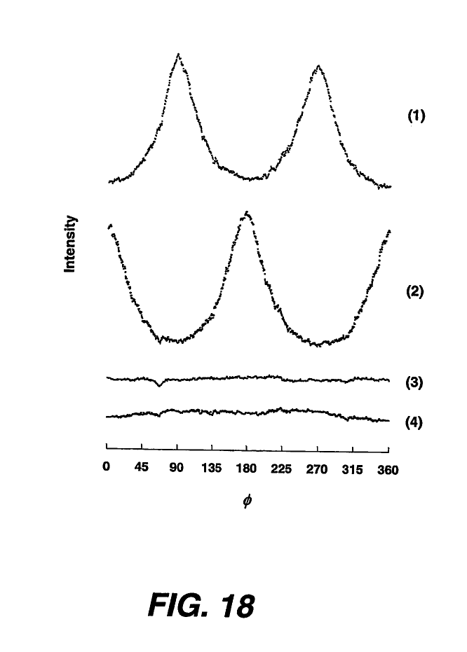

FIG. 18 shows the two-dimensional scattering data integrated in the radial direction to examine the anisotropy of the different specimens. The one-dimensional texture profiles for the aligned nanocomposites are quite anisotropic, showing distinct peaks that are centered 90° from the direction of nanotube orientation. This highly anisotropic texture indicates a significant amount of flow-induced orientation. For both the random nanocomposite and drawn polystyrene, the intensity along azimuthal angle is relatively constant and indicates that both films are essentially isotropic.

The TEM and x-ray diffraction results confirm experimentally that the processing according to the present embodiments result in a highly dispersed and aligned nanocomposite film.

In addition to nanotube orientation, nanotube length is an important parameter. Variation in nanotube length is difficult to quantify from TEM analysis, because a large number of nanotubes are severed when cutting the specimen with a microtome. The lengths of a majority of the nanotubes in the as-processed composite appear to range between 500 nm and 2 □m, with the average length being above 1 □m.

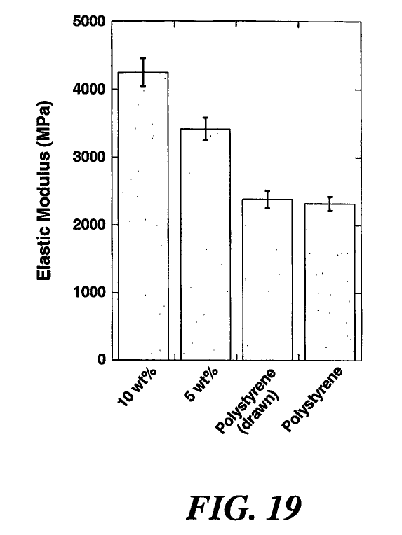

With knowledge of both the nanotube and nanocomposite structures, the micromechanical model developed above can be used to predict the properties of the model nanocomposite system. To compare the predictions for nanotube tensile modulus with the model composite systems, aligned nanocomposite films with 5 and 10 wt % nanotubes and unreinforced polystyrene films that were drawn from the melt and prepared with a hot press have been characterized using a Dynamic Mechanical Analyzer (DMA 2980—TA Instruments) in constant frequency mode (1 Hz, 5° C./min). FIG. 19 summarizes the values obtained for the average elastic storage modulus for nanocomposite films and unreinforced polystyrene at 25° C. Polystyrene, an amorphous polymer, was chosen for the matrix material because the influence of drawing on elastic modulus would be negligible, enabling the direct examination of nanotube reinforcement on the composite elastic properties. Drawing of the polystyrene film resulted in a slight average increase in elastic modulus, but the modulus results for the drawn and hot-pressed specimens are within experimental scatter. Thus, the increase in elastic modulus between the random and aligned nanocomposite is a consequence of load transfer to the nanotubes, not polymer chain orientation.

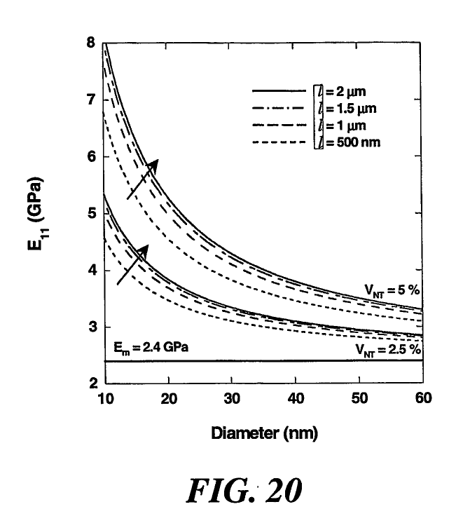

For input into the micromechanical model, the modulus of the nanotube, E_{NT}, is assumed to be 1 TPa and the modulus of the matrix, from the characterization results for unreinforced polystyrene is taken at 2.4 GPa. FIG. 20 shows the influence of nanotube diameter, length and volume fraction on the composite elastic modulus as predicted by Equation (9). While there is a slight increase in elastic modulus at a given nanotube diameter and volume fraction with increasing nanotube length, the diameter of the nanotubes plays the most significant role in the composite elastic modulus. This strong diameter-dependence of the composite elastic modulus highlights the need to accurately model the dispersion of nanotube diameters in the composite.

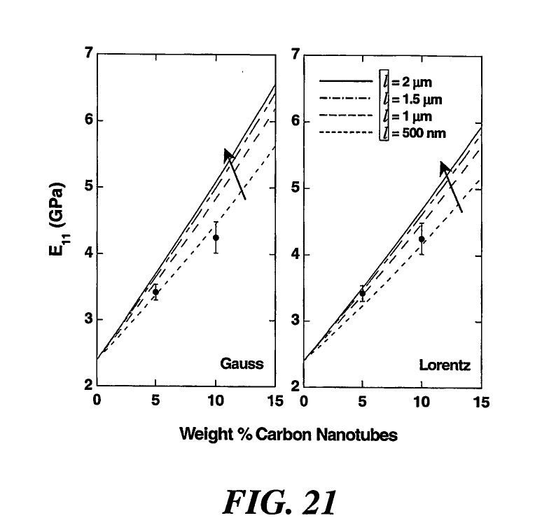

To illustrate the importance of modeling the nanotube diameter distribution, the modeling processes discussed above were used in combination with the structural characterization of the model composite to predict the elastic properties of the composite as a function of the nanotube weight %. For conversion of weight loading of nanotubes to volume loading, the density of the matrix was assumed to be 1 g/cm³. FIG. 21 shows a direct comparison of the calculated nanotube elastic modulus of varying length nanotubes with the experimental results. For the Lorentz distributions, the calculated elastic modulus compares quite well with the results from the experimental characterization. The Gauss distribution, which ignores the contribution of the larger diameter nanotubes, results in an overestimation of the composite elastic modulus, particularly at higher loading fractions.

Specific examples of the production of nanocomposites will now be discussed.

### EXAMPLE 1

A micro-scale twin-screw extruder was used to obtain high shear mixing necessary to disentangle CVD-grown multi-walled nanotubes and to disperse them uniformly in a polystyrene thermoplastic matrix.

The polymer melt was then extruded through a rectangular die and drawn under tension before solidification. The process of extruding the nanocomposite through the die and subsequent drawing resulted in a continuous ribbon of aligned nanocomposites. These aligned nanocomposite films could be subsequently laminated using traditional composites processing techniques such as autoclave or tape placement techniques to create macro-scale aligned nanocomposites.

The structure of the films was investigated using electron microscopy and the tensile behavior characterized using a dynamic mechanical analyzer.

The micro-scale twin-screw extruder can be used to achieve dispersion of multi-walled carbon nanotubes in a thermoplastic/thermoset polymer matrix. In the present examples a polystyrene matrix was used, but the other thermoplastic/thermoset polymer matrix mixes may also be used.

Randomly oriented nanocomposites were also produced by achieving dispersion first with the twin-screw extruder, followed by pressing a film using a hydraulic press.

The tensile behavior of both the aligned and random nanocomposite films with 5 wt. % loading of nanotubes were characterized. Addition of nanotubes increased the tensile modulus, yield strength, and ultimate strengths of the polymer films. The improvement in elastic modulus with the aligned nanotube composite is 5 times greater than the randomly oriented composite.

### EXAMPLE 2

In another embodiment, carbon nanotubes were first dispersed in a solvent and placed in a sonicator bath for mixing. The mixture was sonicated for at least 15 minutes. Under continued sonication, a polymer compatible with the solvent was slowly added to the nanotube/solvent mixture until completely dissolved. The nanotube/solvent/polymer was sonicated for at least 15 minutes until enough solvent evaporated to form a viscous mixture. The solvent was then allowed to evaporate and the remaining nanotube/polymer mixture was dried in a vacuum oven.

After drying, the nanotube/polymer solids were fed into a twin-screw extruder and the temperature, mixing rate, and mixing time were specified to obtain high shear stresses in the extruder flow. The molten polymer was then extruded through a die and drawn under tension to form a continuous ribbon of the polymer/nanotube mixture.

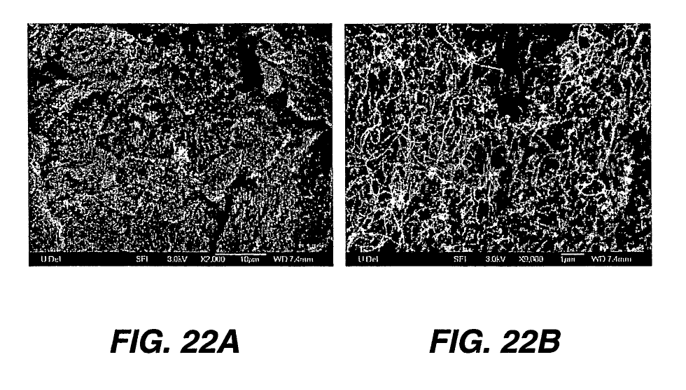

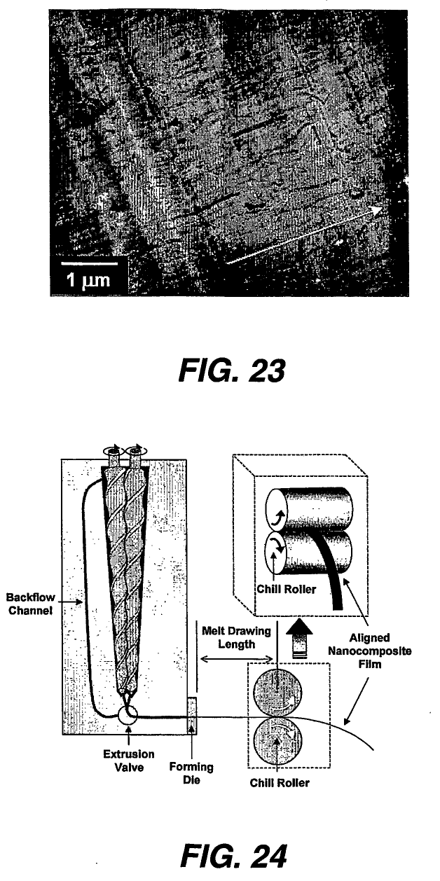

Resulting electron microscopy shows both dispersion of the carbon nanotubes and alignment in a primary direction. FIGS. 22A and 22A show the bulk carbon nanotubes that are entangled and form large agglomerates on the millimeter or micrometer scales. FIG. 23 shows the cross-section of a polymer composite where the nanotubes are uniformly dispersed and aligned in a primary direction (the white arrow indicates the direction of orientation.

Although this technique was developed for a thermoplastic polymer (polymers that melt and flow when heated), it is also applicable to thermoset materials (polymers that react when heated and become more solid) where the viscosity of the thermoset material at the processing temperature is high enough (such as with a partially cured or b-staged thermoset) to undergo the same shear and extensional flow stresses.

On a larger scale, it may be possible to eliminate the step of solvent polymer/nanotube/solvent mixing and obtain mixing, dispersion and alignment in a single step. The process of extruding the nanocomposite through the die and subsequent drawing results in a continuous ribbon of aligned nanocomposite with uniform dispersion of carbon nanotubes. These aligned nanocomposite films could be subsequently laminated using traditional composites processing techniques (e.g. autoclave or tape placement techniques) to create macro-scale aligned nanocomposites or nanoscale devices.

### EXAMPLE 3

To disperse CVD-grown multi-walled carbon nanotubes in a polystyrene matrix, a micro-scale twin-screw extruder (DACA Instruments—Goleta, Calif.) was used to obtain the high shear mixing necessary to disentangle and disperse the nanotubes.

To obtain tight control over the weight fraction of nanotubes within the polymer and minimize exposure to nanotubes that become airborne, 3.5 g of polystyrene (280K M_{w}—Scientific Polymer, Inc) was dissolved in tetrahydrofuran (THF) and mixed with 184.2 mg of nanotube powder.

The solution was cast in a petri dish and sonicated as the solvent was evaporated. The purpose of sonication was not to enhance the nano-scale dispersion of nanotubes within the polymer but rather to assure the nanotubes were dispersed on the microscale so that they are encapsulated within the polymer after evaporation of the solvent.

After drying, the mixture of nanotubes and polymer was then fed into the extruder, which was pre-heated to 155° C., and the polymer was melted and subsequently mixed for three minutes at a screw speed of 100 RPM to disperse the nanotubes within the matrix.

The polymer melt was then extruded through a rectangular die (w=13 mm, t=0.35 mm). As the polymer melt exited the die, the film was drawn in the molten state at various take-up rates and passed-over a chill roll to solidify.

The drawn length and mass flow rate was recorded during the extrusion process to ensure consistent draw ratios from batch-to-batch. The as-drawn films ranged between 80 and 120 microns in thickness, depending on the draw ratio.

Unreinforced polystyrene films were also processed using the same technique and draw ratios. To understand the influence of drawing on the properties of the polymer and nanocomposite, specimens were also produced without drawing by compounding the material in the extruder followed by molding of the film in a hot press.

### EXAMPLE 4

To achieve a homogeneous distribution of nanotubes in the polystyrene matrix, a processing method was developed that combines solvent-assisted dispersion of nanotubes in the polymer followed by shear mixing of the polymer melt using a micro-scale twin-screw extruder. Aligned nanocomposite films were formed by subsequently drawing the molten polymer prior to solidification, and the extensional flow from drawing results in significant flow-induced alignment of nanotubes. Optimum processing parameters (mixing time, shear stress, draw ratio) to achieve a high degree of dispersion and alignment were determined experimentally by processing nanocomposite films using the micro-scale extruder and investigating the micro and nano-scale structure using transmission electron microscopy.

FIG. 24 is a schematic diagram of the micro-scale extrusion system (DACA Instruments—Goleta, Calif.). Unlike a traditional twin-screw extruder, where the length of the screws, and hence mixing time, are fixed, the design of the micro-scale extruder used in this work utilizes conical-shaped co-rotating screws that are 10 cm in length in combination with a backflow channel that allows re-circulation of the polymer through the extruder barrel. This capability for continuous mixing enables small batches of model nanocomposites to be processed with flexible mixing times. The total volume of the extruder barrel and backflow channel is 5 cm³.

After shear mixing, the extrusion valve is turned so that the polymer flows out of the extruder through a forming die (FIG. 24). Extruding the polymer through a rectangular forming die produces a film that can be drawn in the molten state by varying the take-up rate as the film passes over the chill roller. The drawing length is fixed at 1.6 cm and the take-up rate is continuously variable up to 175 cm/minute.

Due to the limited quantity of carbon nanotubes available, two compositions were investigated for the model nanocomposites (5 and 10 wt %). The nanocomposites were prepared by first dispersing the carbon nanotubes in tetrahydrofuran (THF) using a low energy ultrasonic mixing bath (80 W, 47 kHz). Prior to dispersion, large agglomerates of carbon nanotubes were broken-up using a mortar and pestle. After sonic mixing for at least 45 minutes, 3.5 g of polystyrene was slowly dissolved and, after continued ultrasonic mixing of the polymer/nanotube solution, the solvent was evaporated. The mixture was further dried in air at 60° C. for four hours and under vacuum at 80° C. for two hours to remove any residual solvent.

Solvent-assisted dispersion of nanotubes in the polymer enables tight control over the nanotube weight fraction and also minimizes exposure to nanotubes that may become airborne. The purpose of sonication was not to enhance the nano-scale dispersion of nanotubes within the polystyrene but rather to assure that the nanotubes were dispersed on the micro-scale. This micro-scale dispersion of nanotubes ensures that the nanotubes are completely encapsulated within the polymer after evaporation of the solvent.

After drying, the polymer/nanotube mixture was then compounded using the micro-scale extruder. Because micro-scale extrusion is a batch process, the flow rate during extrusion of the films does not remain constant; the flow rate decreases over time because the barrel pressure decreases as polymer is extruded.

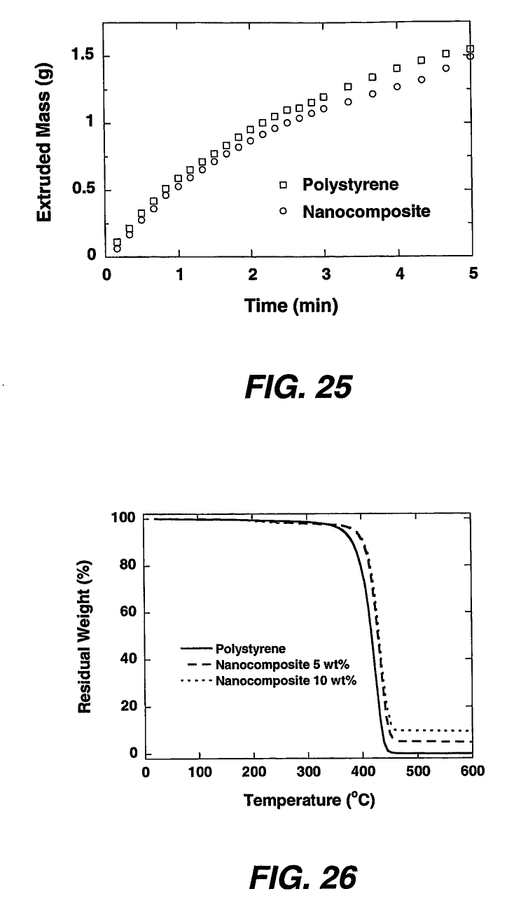

FIG. 25 shows the mass extruded from the barrel during the formation of both nanocomposite and polymer films. For controlled drawing of the films, the mass of polymer compounded was kept constant (3.5 g) for all experiments, and the drawn length and mass flow rate was recorded during the extrusion process to ensure consistent draw ratios from batch-to-batch. During the first minute of extrusion, the flow rate is the highest and relatively constant at 0.6 grams per minute. At longer times, the flow rates for both the nanocomposite and unreinforced polymer decrease significantly and begin to diverge. For structure and property characterization, all aligned model nanocomposites were obtained during the first minute of extrusion.

Based on a series of experiments involving the production of composites using different processing parameters and subsequent structure characterization using TEM, processing parameters were chosen to fabricate the model nanocomposites. After solvent evaporation the micro-extruder was pre-heated to 155° C. and the polymer was melted and then mixed for three minutes at a screw speed of 100 RPM to disperse the nanotubes within the matrix. The screw speed was reduced to 20 RPM and the polymer melt extruded through a rectangular die (w=13mm, t=0.35 mm).

As the polymer exited the die, the film was drawn in the molten state at various take-up rates and passed-over a chill roll to solidify. By examining the drawn films, it was determined that a draw ratio of 5, as defined by change in length of the drawn film relative to the calculated length of a film of the same mass with a cross-section equivalent to the dimensions of the extrusion die, resulted in good nanotube alignment of the film without excessive drawing. The as-drawn films ranged between 80 and 120 microns in thickness, depending on the draw ratio. Unreinforced polystyrene films were also processed using the same technique and draw ratios.

To understand the influence of drawing on the mechanical properties of the polymer and nanocomposite, specimens were also produced without drawing by compounding the material in the extruder followed by molding of the film in a hot press. Without extensional flow from the drawing process, the orientation of nanotubes in the composite is random.

To validate the weight percentage of nanotubes in the polymer matrix and also confirm that nanotubes are distributed throughout the matrix on the microscopic scale, thermogravimetric analysis (TGA) experiments were performed on the nanocomposite specimens as well as the unreinforced polymer. In TGA, the weight is measured as the sample is heated at a constant rate through its degradation temperature. Carbon nanotubes are thermally stable at much higher temperatures than the polystyrene matrix. After pyrolysis of the matrix, the residual mass can be utilized to calculate the weight percentage of nanotubes in the composite. TGA scans were performed under a flowing helium atmosphere and a heating rate of 20° C./min (TA Instruments Q500 TGA).

FIG. 26 shows TGA results for the different compositions. After pyrolysis, the polystyrene is completely decomposed, and the residual weight of nanotubes can be taken as the weight percentage of nanotubes within the composite. As shown in FIG. 2.5, the 5 and 10 wt. % specimens show residual weight corresponding to their compositions. TGA scans on all of the nanocomposite specimens were less than ±0.1% of the original composition, indicating both tight control over the nanotube loading content and uniform dispersion of nanotubes throughout the polymer matrix.

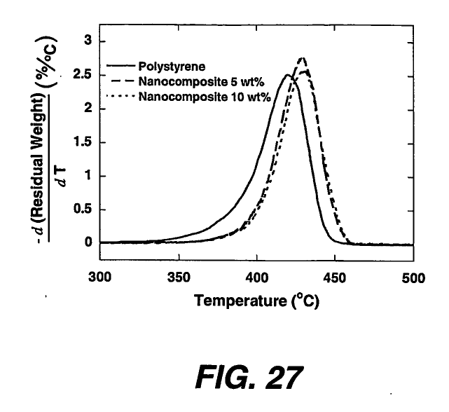

In addition to validation of the nanocomposite composition, the TGA results in FIG. 26 show that the onset of degradation for the nanocomposites occurs at a slightly higher temperature than the bulk polystyrene. FIG. 27 shows the first derivative of the TGA scans. The broad single peak for degradation of polystyrene is consistent with degradation resulting from thermally activated scission of the polymer chain. The nanocomposite specimens show similar peaks as the polystyrene but with peak positions, indicating the highest rate of degradation, shifted from 418° C. to 430° C. The breadths of the peaks for the nanocomposite specimens are also slightly reduced. This slight improvement in the thermal stability for polystyrene, which is independent of nanotube loading, is likely a consequence of the inorganic carbon nanotubes distributed throughout the polystyrene impeding the diffusion of degradation products within the nanocomposite.

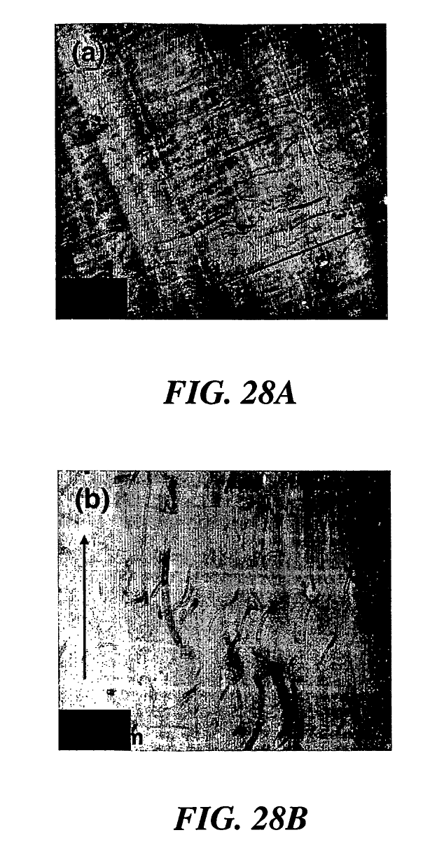

FIGS. 28A and 28B are TEM micrographs of nanocomposite films that were extruded using the microcompounder, and the arrows indicate the flow/drawing direction. To examine the influence of drawing on the nanotube orientation, samples were sectioned parallel to the flow/drawing direction. Once the nanocomposite films were sectioned, a microtome was used to cut slices of the films for observation in the TEM. Samples for TEM were relatively thick (200 nm) so as to minimize distortion of the structure by cutting the film with a diamond knife, and the cutting direction of the microtome knife was perpendicular to the flow/drawing direction. The horizontal gray lines in the TEM micrographs are artifacts from the cutting process and indicate that the film was cut normal to the direction of orientation. The TEM microgaphs show good dispersion of nanotubes and wet-out by the polymer matrix. In addition, drawing of the film from the melt resulted in significant alignment of the nanotubes within the polymer matrix.

FIG. 28A shows large-scale dispersion and overall alignment of the carbon nanotubes and FIG. 28B shows nanoscale tube alignment, particularly of the smaller diameter nanotubes not visible at the lower magnifications. By examining the drawn films, it was determined that a draw ratio of 5, as defined by change in length of the drawn film relative to the calculated length of a film of the same mass with a cross-section equivalent to the dimensions of the extrusion die, resulted in good nanotube alignment of the film without excessive drawing.

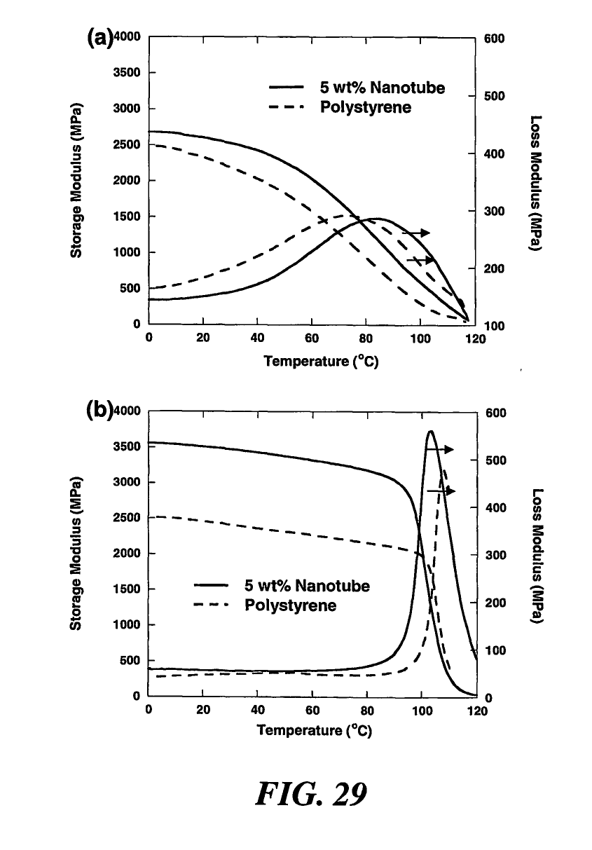

The films were then characterized using a Dynamic Mechanical Analyzer (DMA 2980—TA Instruments) in constant frequency and controlled force modes. FIGS. 29A and 29B show results of the constant frequency temperature scan (1 Hz, 5° C./min) on the elastic and damping behavior of the films made in the hot press and drawn from the melt, respectively. For the films manufactured using a hot press, the orientation of the nanotubes is random. The addition of nanotubes results in a moderate increase in the elastic, storage modulus over the unreinforced polymer.

FIG. 29B shows the influence of nanotube orientation. As compared to the bulk polymer, the storage modulus at 25° C. of the aligned composites increased 49% as opposed to a 10% increase for the randomly oriented composites, resulting in a five-fold relative increase for the aligned system over the random system. As expected, drawing of the polymer films resulted in a narrowing of the loss modulus peak and a peak shift to higher temperatures since the drawn films will result in higher molecular packing and lower free volume.

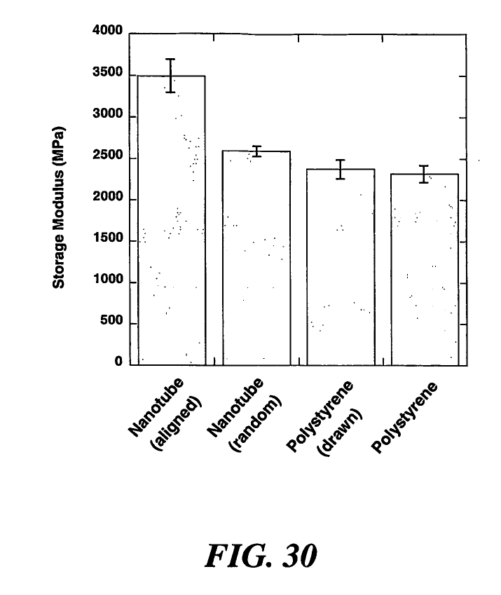

FIG. 30 shows the average storage modulus results at 25° C. for the various films. Polystyrene, an amorphous polymer, was chosen for the matrix material because the influence of drawing on elastic modulus would be negligible, enabling the direct examination of nanotube orientation on the elastic properties. Drawing of the polystyrene film resulted in a slight average increase in elastic modulus, but the modulus results for the drawn and hot-pressed specimens are within experimental scatter. Thus, the increase in elastic modulus between the random and aligned nanocomposite is a consequence of the nanotube orientation, not polymer chain orientation.

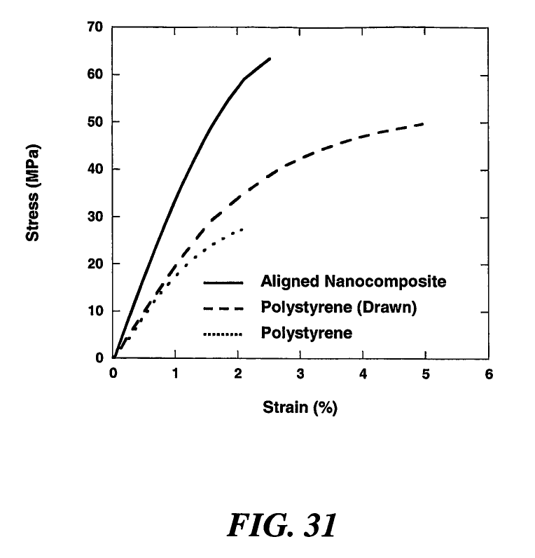

To examine the influence of nanotubes on deformation and fracture behavior of the polymer films, the DMA was operated under controlled force mode to obtain static stress-strain curves (2 N/min, 25° C.). FIG. 31 shows that, in addition to the increase in elastic modulus, orientation of the nanotubes results in improvements in the yield strength and ultimate strength as compared to the unreinforced polystyrene films.

Increases in elastic modulus, yield strength, and ultimate strength indicate that nanotubes are acting as reinforcement in the polymer matrix by transferring load from the polymer to the nanotubes. Although the improvements in elastic modulus is lower than if it were assumed that the nanotube acts as a solid fiber with an elastic modulus of 1 TPa, the anisotropy of the aligned film as opposed to the random film is apparent and indicates that the nanotubes are acting as a fiber-like reinforcement in transferring axial load from the matrix via shear in the aligned composite system.

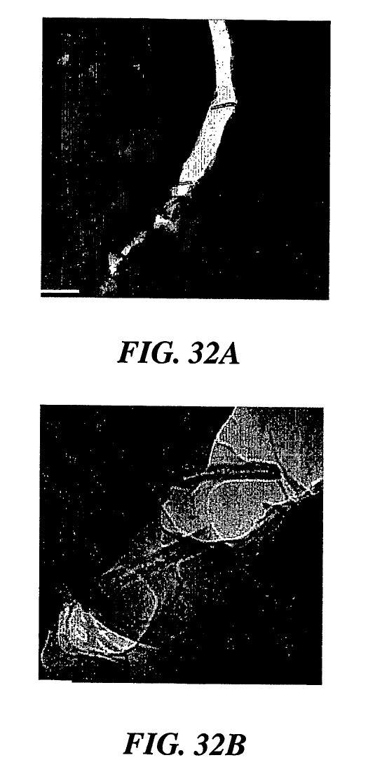

In FIG. 32A, a TEM micrograph of a nanocomposite film specimen shows a crack interacting with the nanotube reinforcement. It can be seen that a nanotube is bridging the crack, and a closer examination of the crack tip (FIG. 32B) reveals broken nanotubes. The presence of fractured tubes along with the matrix still adhered to the fractured tube indicates good wetting and adhesion of the nanotubes with the matrix.

A rectangular die was used in the embodiments discussed above in order to enhance alignment of the nanotubes within the polymer matrices. However, other dies shapes, such as circular, may also be used.

Thermoset/thermoplastic polymers are described in Stevens, Malcolm P, Polymer chemistry: an introduction 3rd ed., New York Oxford University Press, 1999, the entire contents of which are hereby incorporated by reference.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### STATEMENT OF INDUSTRIAL APPLICABILITY

This has industrial applicability for uses in structural, electrical (e.g. EMI shielding, electronics) and thermal (e.g. heat dissipation) applications for multi-functional materials and devices based upon carbon nanotubes, among other uses.

What is claimed is:

1. A method for producing nanocomposites, comprising:
providing a mixture of polymer and nanotubes;
shear mixing the mixture in an extruder to disperse the nanotubes within the polymer;
extruding the mixture from the extruder; and
drawing the mixture prior to solidification of the mixture.

2. The method of claim 1, wherein the extruder is a micro-scale extruder having conical co-rotating screws.

3. The method of claim 2, wherein the extruder includes a backflow channel that allows re-circulation of the mixture through a barrel of the extruder.

4. The method of claim 1, wherein extruding the mixture comprises:
extruding the mixture through a die.

5. The method of claim 4, wherein the die is rectangular and extruding through a rectangular die forms a film from the mixture.

6. The method of claim 5, comprising:
passing the film over a chill roller.

7. The method of claim 1, wherein providing a mixture of polymer and nanotubes comprises:
dispersing the nanotubes in a solvent; and
sonicating the resulting mixture.

8. The method of claim 1, wherein providing a mixture of polymer and nanotubes comprises:
dissolving a polymer in the solvent; and
drying to remove the solvent.

9. The method of claim 8, comprising:
melting the mixture prior to extrusion.

10. The method of claim 1, wherein drawing the mixture is performed at a draw ratio of about 5.

11. The method of claim 1, wherein the polymer is selected from the group consisting of:
thermoplastic polymers and thermoset materials.

12. The method of claim 1, wherein the nanotubes are carbon nanotubes.

13. The method of claim 1, comprising:
recirculating the mixture through the extruder through a backflow path.

14. The method of claim 1, comprising:
controlling the viscosity of the mixture by controlling a temperature of the extruder;

15. A film produced from the nanocomposite of claim 1.

16. A nanocomposite, comprising:
a plurality of nanotubes dispersed in a polymer matrix, wherein the nanotubes are mechanically aligned in a principal direction to a standard deviation from the principal direction of less than ±15°.

17. The nanocomposite of claim 16, wherein the polymer is selected from the group consisting of:
thermoplastic polymers and thermoset materials.

18. The nanocomposite of claim 16, wherein the nanocomposite is a continuous ribbon.

19. A method for producing nanocomposites, comprising:
providing a mixture of polymer and nanotubes, wherein the nanotubes are selected according to their diameters;
shear mixing the mixture to disperse the nanotubes within the polymer;
extruding the mixture from the extruder; and
drawing the mixture prior to solidification of the mixture to form a nanocomposite, wherein the distribution of nanotube diameters is selected according to a desired stiffness of the nanocomposite.
